(19) United States
(12) Patent Application Publication
(10) Pub. No.: US 2018/0133915 A1
(43) Pub. Date: May 17, 2018

(54) APPARATUS FOR PROCESSING A FOOD PRODUCT AND CORRESPONDING METHOD

(71) Applicant: GELMINI SRL, Langhirano (PR) (IT)

(72) Inventor: Marco MANTOVANI, Langhirano (PR) (IT)

(21) Appl. No.: 15/349,056

(22) Filed: Nov. 11, 2016

(51) Int. Cl. B26D 3/24; B26D 5/00

(52) U.S. Cl. CPC B26D 3/24; B26D 5/005

(57) ABSTRACT

Apparatus for processing a food product, such as a wheel of hard or semihard cheese, comprising:
a disking unit configured to cut the food product and to obtain disks;
a holing unit configured to make a hole in each of the disks to define an intermediate product shaped like a do-nut;
a weighing unit configured to assess the weight of at least one of the disks or said intermediate product;
a cutting unit configured to cut the intermediate product into a plurality of segments.

### FIELD OF THE INVENTION

The present invention concerns an apparatus for processing a food product with a hard or semihard consistency, used for example in the field of working cheese wheels, such as Italian “Grana” cheese, or hard or semihard cheese.

### BACKGROUND OF THE INVENTION

In the field of distribution and sale of food products, in particular cheeses, it is known to supply clients with portions of a wheel of cheese for example in the form of segments.

In fact, it is known that, at the end of the cheese production line, before it is distributed on the market, the cheese has a substantially cylindrical axial-symmetric shape, possibly rounded near its central portion and with an overall weight that can vary from a few kilograms to some dozen kilograms.

To obtain smaller portions of cheese, for example in the classic segment configuration, a plurality of apparatuses are known, each managed by an operator, which starting from the whole wheel of cheese allow to successively obtain limited portions in segments.

Such apparatuses can be both the manual and the automated type.

In the case of automated apparatuses, each of them is independent of the other with their own management and control units of the various operating components present.

Each apparatus is configured to perform on the cheese a determinate operation to allow to obtain, at the end of the production cycle, segments to be sent for distribution, possibly after packaging.

The various apparatuses present, most of the time, are not suitably connected to each other and the semiworked products are usually transferred manually from one apparatus to the other, with consequent disadvantages in terms of times and precision of the operations performed.

Solutions are also known where manipulators are interposed between the working apparatuses, to move the semiworked products from one apparatus to the other.

Transfers between the apparatuses not only entail an increase in the downtimes of the process, but also cause imprecise positioning of the cheese, with consequent imprecise workings.

The imprecision of the working, at the end of the work cycle, means that segments of cheese are obtained that are very different from each other in size and weight, which conflicts with the needs of large-scale distribution to make the weight and size of each segment uniform.

One purpose of the present invention is to obtain an apparatus for processing a food product which, starting from the whole wheel of cheese, allows to obtain portions in segments to be sent to distribution.

Another purpose of the present invention is to obtain an apparatus that allows to obtain, from a wheel of cheese, portions in segments with uniform and predetermined shape and sizes.

Another purpose of the present invention is to obtain an efficient apparatus that allows to reduce the downtimes and to increase overall productivity.

Another purpose of the present invention is to perfect a method for processing a food product that is rapid and precise to obtain portions in segments with uniform and predetermined shape and sizes.

The Applicant has devised, tested and embodied the present invention to overcome the shortcomings of the state of the art and to obtain these and other purposes and advantages.

### SUMMARY OF THE INVENTION

The present invention is set forth and characterized in the independent claims, while the dependent claims describe other characteristics of the invention or variants to the main inventive idea.

In accordance with the above purposes, an apparatus according to the present invention for processing a food product, such as a wheel of hard or semihard cheese, comprises the following units placed in sequence:
a disking unit configured to cut the food product and to obtain disks;
a holing unit configured to make a hole in each of the disks to define an intermediate product shaped like a do-nut;
a weighing unit configured to assess the weight of at least one of the disks or the intermediate product;
a cutting unit configured to cut the intermediate product into a plurality of segments,
   the holing unit, the weighing unit and the cutting unit being positioned adjacent to each other and aligned along a common working axis.

According to possible variant embodiments the disking unit can be positioned adjacent to the working axis to allow the loading operations of the food product by the operators. Moreover, this solution also facilitates the operators in possible maintenance operations required by the disking unit.

According to a variant embodiment, the disking unit can also be positioned aligned along the working axis, in this way obtaining a uniform and linear disposition of the entire apparatus.

Embodiments of the present invention also concern a method for the processing of a food product such as a hard or semihard cheese that comprises:
cutting the food product into a plurality of disks;
making a hole in each of the disks to define an intermediate product shaped like a do-nut;
assessing the weight of at least one of the disks or of the intermediate product;
cutting the intermediate product into a plurality of segments, the operations of cutting the food product, making the hole, assessing the weight and cutting the intermediate product being carried out one after the other along a common working axis.

### BRIEF DESCRIPTION OF THE DRAWINGS

These and other characteristics of the present invention will become apparent from the following description of some embodiments, given as a non-restrictive example with reference to the attached drawings wherein:

FIG. 1 is a lateral view of an apparatus to process a food product in accordance with a possible embodiment of the present invention;

FIG. 2 is a plan view of FIG. 1;

FIG. 2a is a variant of FIG. 2;

FIG. 3 is a perspective view of an operating unit of the apparatus in FIG. 1;

FIG. 4 is a perspective view of components of the unit in FIG. 3;

FIG. 5 is a schematic representation in plan of FIG. 4;

FIG. 6 is a section view of a component of an operating unit of the apparatus in FIG. 1;

FIG. 7 is a schematic and partly sectioned view of an operating unit of the apparatus in FIG. 1;

FIG. 8 is a schematic and partly sectioned view of a variant of FIG. 7;

FIG. 9 is a perspective view of a detail of a component of the apparatus in FIG. 1 in accordance with possible embodiments.

To facilitate comprehension, the same reference numbers have been used, where possible, to identify identical common elements in the drawings. It is understood that elements and characteristics of one embodiment can conveniently be incorporated into other embodiments without further clarifications.

### DETAILED DESCRIPTION OF SOME EMBODIMENTS

An apparatus for processing a food product, such as a wheel of hard or semihard cheese 11, is indicated in its entirety by the reference number 10 and is configured to work a food product with a substantially axial-symmetric shape, cylindrical and possibly rounded in the central portion.

According to possible embodiments, the apparatus 10 according to the present invention comprises at least one of the following operating units:
a disking unit 13 configured to cut the wheel of cheese 11 transversely to its axial development and to obtain from the wheel of cheese 11 at least two disks 12 or semiwheels, or more than two disks 12;
a holing unit, also hereafter called coring unit 14 configured to make a hole 17 in each of said disks 12 and in its central zone, to define an intermediate product shaped like a do-nut;
a weighing unit 15 configured to assess the weight of the disk 12, also after the coring operation;
a cutting unit 16 configured to cut the intermediate product 18 into a plurality of segments 19.

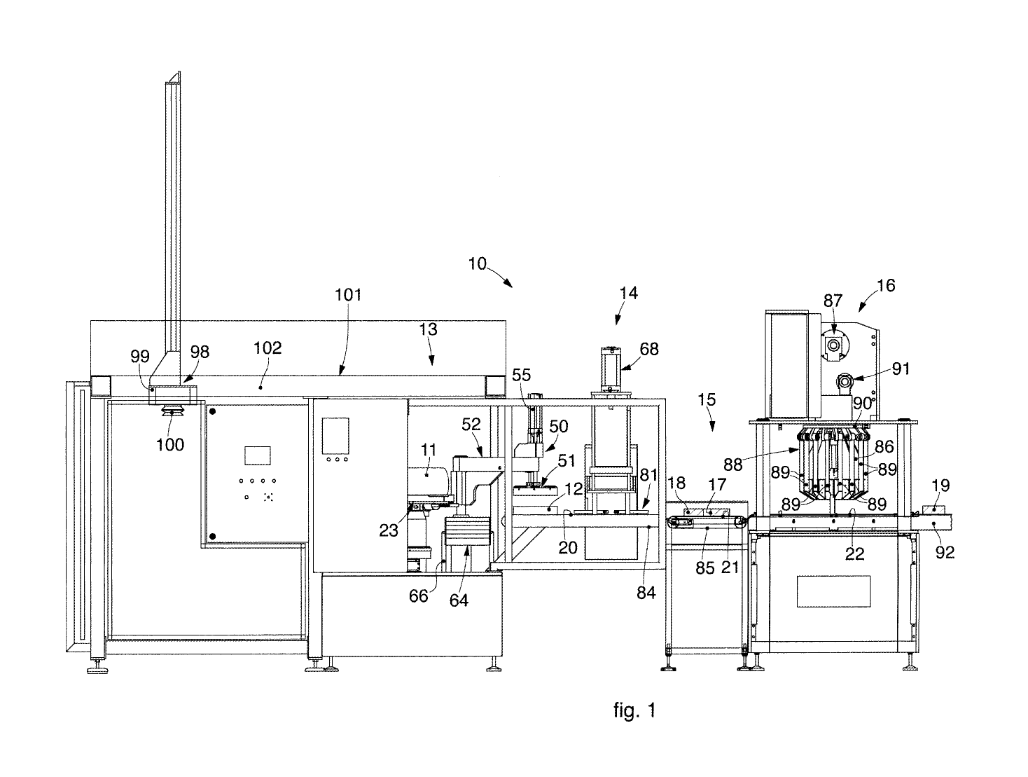

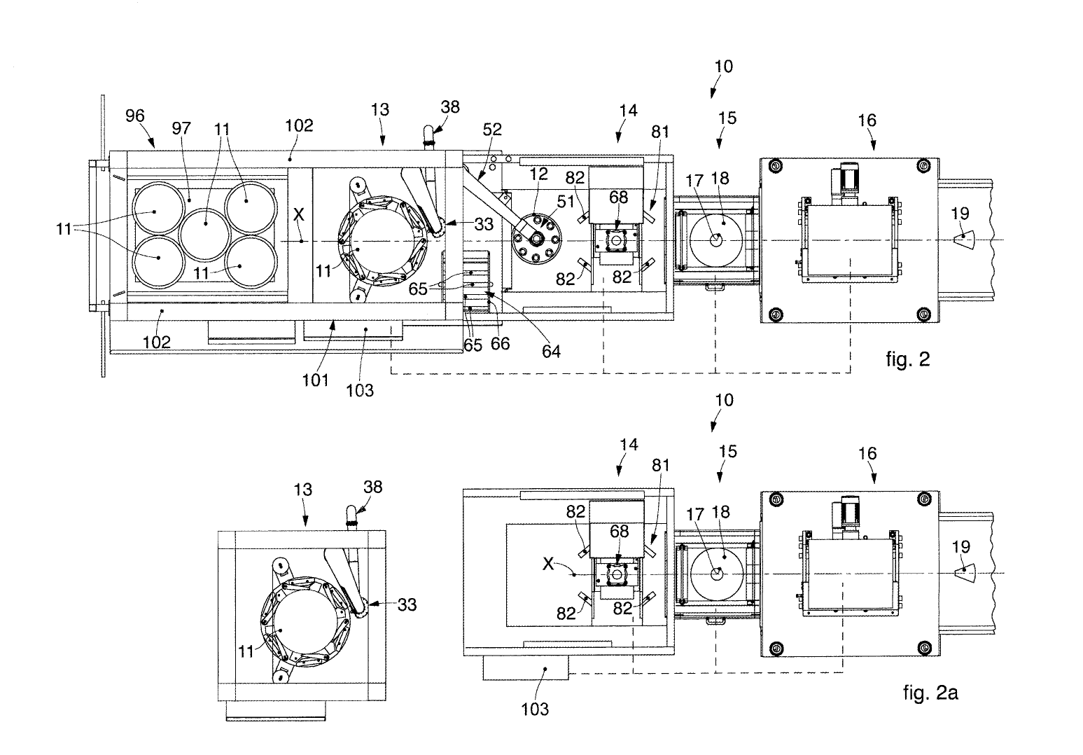

According to a possible embodiment, for example shown in FIGS. 1 and 2, at least the coring unit 14, the weighing unit 15 and the cutting unit 16 are positioned adjacent to each other and aligned along a common working axis X.

According to a possible solution, it can be provided that the disking unit 13 is also adjacent to the other units 14-16, and aligned along the working axis X, as shown in FIG. 2.

According to a possible variant embodiment, shown in FIG. 2a, the disking unit 13 is separate and independent from the other units 14-16. In this embodiment the disking unit 13 is distanced from the coring unit 14 and adjacent to the working axis X.

According to possible embodiments, the weighing unit 15 can be interposed between the coring unit 14 and the cutting unit 16, as shown for example in FIGS. 1 and 2.

According to a possible variant embodiment, the weighing unit 15 can be interposed between the disking unit 13 and the coring unit 14.

According to a possible formulation of the present invention, the coring unit 14 is disposed immediately downstream of the disking unit 13.

According to possible solutions the apparatus comprises movement members 84, 85, 92, described hereafter, and provided in or between the coring unit 14, the weighing unit 15 and the cutting unit 16 to move at least the disks 12, the intermediate product 18 and the segments 19 along the working axis X.

According to other embodiments, the coring unit 14, the weighing unit 15 and the cutting unit 16 are provided with respective work planes respectively 20, 21 and 22 all lying aligned on a single plane. This limits the movements to which the food product is subjected during working to obtain the final segments 19.

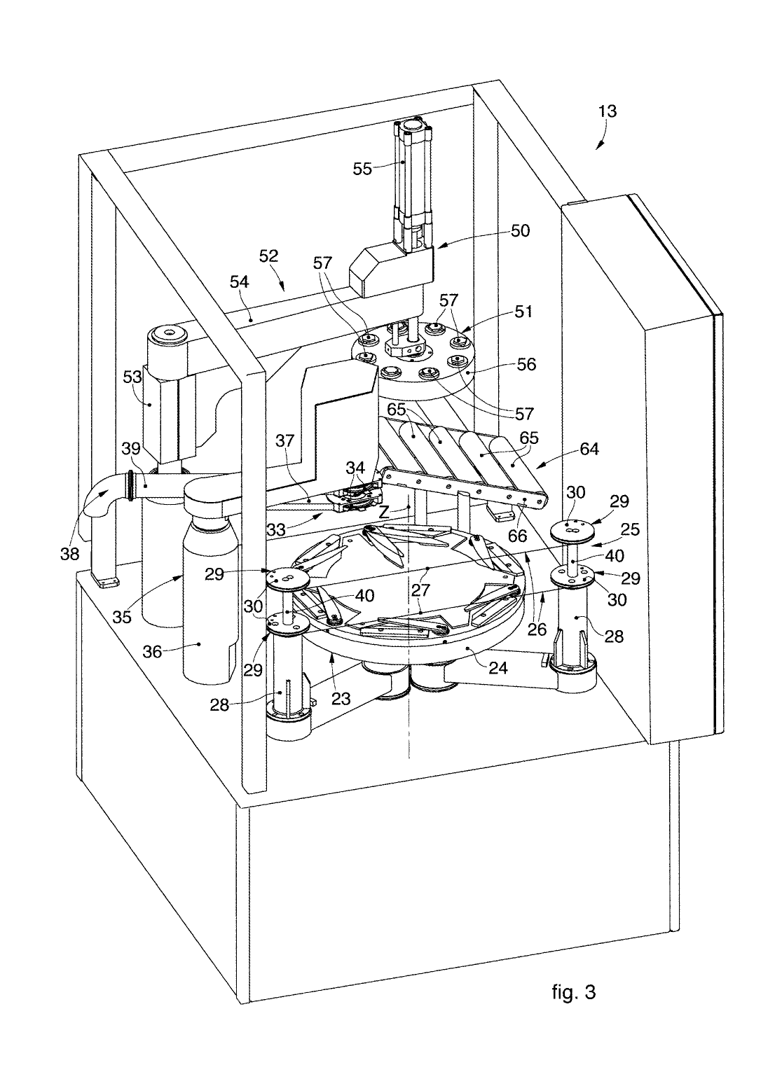

FIGS. 3, 4, 5 and 6 are used to describe possible embodiments of the disking unit 13 according to the present invention.

The disking unit 13 comprises a support body 23 suitable to support a wheel of cheese 11 during working.

The support body 23 is provided with a support platform 24, substantially circular, on which the wheel of cheese 11 is positioned during use.

Cutting devices 25 are associated with the support body 23, configured to cut the wheel of cheese 11 into disks 12.

In possible embodiments, the cutting devices 25 can comprise at least a cutting tool 26 suitable to cut the wheel of cheese 11 transversely to its axial development in order to obtain the disks 12.

A possible implementation of the present invention provides that the cutting tool 26 comprises a wire 27.

The wire 27 can be made of stainless steel. According to possible solutions, the wire 27 can be provided, on its peripheral surface, with a plurality of protrusions or ridges, configured to give the wire 27 a greater cutting action.

According to possible formulations of the present invention, the cutting device 25 comprises two support arms 28 located on the perimeter of the support body 23 and selectively movable, by suitable actuation members, around the support body 23 to give the cutting tool 26 the cutting motion.

The actuation members can comprise, merely by way of example, a hydraulic motor, an electric motor, toothed wheels, toothed crowns, rotation shafts or possible combinations thereof.

On each support arm 28 an end of the wire 27 is mounted, and the support arms 28 provide to keep the latter under tension around the wheel of cheese 11 being worked.

The cutting device 25 can comprise winding/unwinding members 29 of the wire 27, suitable to put it under tension and allow to make the cut.

According to the solution shown for example in FIG. 3, each of the winding/unwinding members 29 is mounted on one of the support arms 28 to put the wire 27 under tension around the wheel of cheese 11.

To this purpose the winding/unwinding members 29 can each comprise a pulley 30 mounted on a respective support arm 28 and on which one end of the wire 27 is wound or unwound. The pulley 30 is connected in turn to drive members, not shown in the drawings and configured to make the pulley 30 rotate, both clockwise and anti-clockwise in order to allow the winding and unwinding action of the wire 27.

During the operating steps of obtaining the disks 12, the support arms 28 pass from an inactive condition, in which the wire 27 is completely wound on the pulleys 30, to an operating condition in which the support arms 28, rotating around the support body 23, take the wire 27 to its condition of maximum extension and activate the cutting action.

When the support arms 28 reach the position circumferentially opposite the inactive condition, the wire 27 is commanded to be rewound, by the winding/unwinding members 29, to complete the cutting of the disk 12.

According to possible embodiments, the cutting devices 25 can comprise positioning members 40 configured to suitably position the cutting tool 26 with respect to the wheel of cheese 11.

According to possible implementations, it can be provided that the winding/unwinding members 29 of the wire 27 are connected to the positioning members 40 which in turn are mounted on the support arms 28. The positioning members 40 in this case have the function of positioning the winding/unwinding members 29 and hence the wire 27 at predetermined heights along the support arm 28. This allows to regulate, for example, the thickness of the disks 12 that are cut on each occasion.

The positioning members 40 can comprise a screw jack, for example, a worm screw mechanism, a rack mechanism, an actuator, or possible combinations thereof.

According to possible variant embodiments, shown for example in FIG. 3, it can be provided that the cutting devices 25 comprise more than one cutting tool 26, each of which is configured to cut a respective disk 12 from the wheel of cheese 11. In this way, by activating the cutting devices 25, all the cutting tools 26 are simultaneously activated to obtain several disks 12 simultaneously.

According to possible embodiments, and if several cutting tools 26 are present, each of them, or at least some of them, can be served by respective positioning members 40 configured to position the cutting tools 26 reciprocally with each other and allow to obtain disks 12 of different or equal heights.

According to possible embodiments, first drive members 31 can be connected to the support body 23, configured to move the support body 23 along a longitudinal axis Z transverse to the flat development of the latter.

The first drive members 31 can be chosen from a group comprising electric, pneumatic or oil-dynamic actuators, screw jacks, rack mechanisms, gears or possible combinations thereof.

The movement of the support body 23 in a direction parallel to the longitudinal axis Z allows to suitably position the wheel of cheese 11 being worked with respect to the cutting devices 25, in order to obtain disks 12 of the desired thickness.

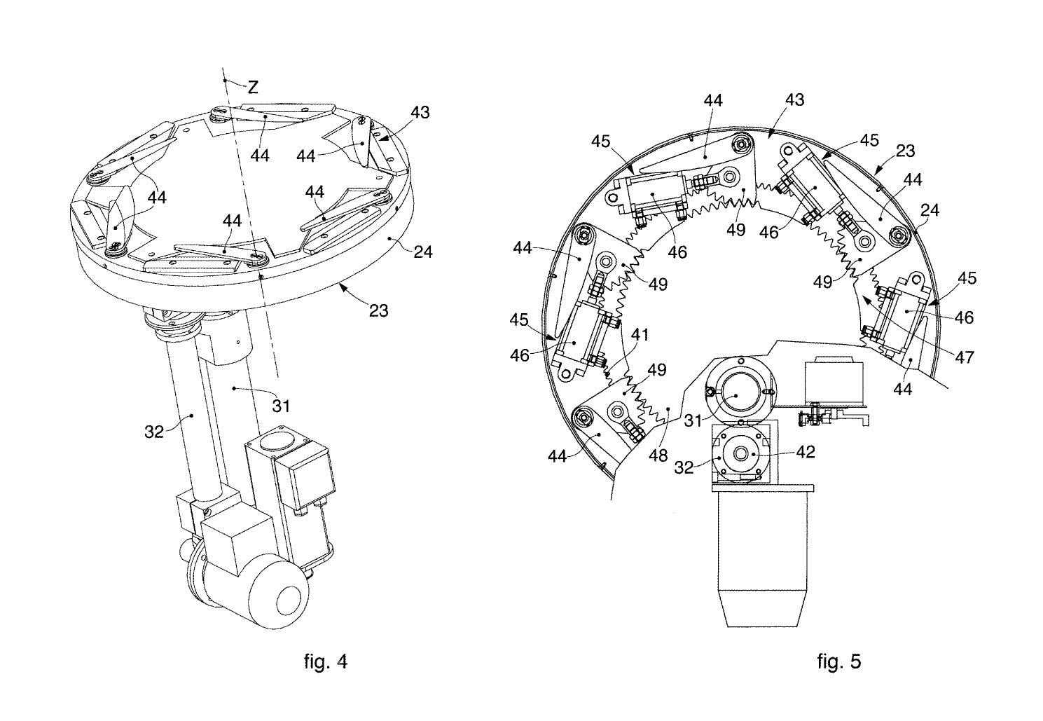

According to other embodiments, possibly combinable with the embodiments described here, second drive members 32 (FIG. 4) can be connected to the support body 23, configured to rotate the support body 23 around the longitudinal axis Z.

According to possible embodiments, for example shown in FIG. 5, a toothed crown 41 is connected to the support platform 24, and during use is configured to engage with a pinion 42 of the second drive members 32. By activating the second drive members 32 the pinion 42 is made to rotate and also the toothed crown 41 that engages thereon. Consequently, the rotation of the support body 23 is determined.

In this way it is possible to make the support platform 24 rotate on itself, and also the wheel of cheese 11 located thereon.

According to possible embodiments (FIG. 3), the disking unit 13 can comprise incision devices 33 configured to incise the surface crust of the lateral surface of the wheel of cheese 11 and generate on it a circumferential groove or incision. The circumferential groove allows to direct and facilitate the cutting by the cutting device 26 described above.

According to a possible embodiment, shown for example in FIG. 3, the incision devices 33 can comprise at least a milling tool 34, the axis of rotation of which is located substantially parallel to the longitudinal axis Z.

The incision devices 33 can comprise a support and positioning member 35 configured to support the milling tool 34 and to position it, during use, tangentially to the circumferential surface of the wheel of cheese 11.

In a possible solution, the support and positioning member 35 can comprise a column 36 and an arm 37 mounted cantilevered on the column 36.

The at least one milling tool 34 is mounted on the free end of the arm 37.

Actuation members are connected to the column 36, or directly to the arm 37, and are configured to rotate at least the arm 37 around the axis of longitudinal development of the column 36 and to make the milling tool 34 assume at least an operating condition in which the milling tool 34 is put in contact against the circumferential surface of the wheel of cheese 11, and a non-operating condition, in which the milling tool 34 is put in a position of non-interference with the other operating components of the disking unit 13.

According to a variant embodiment, not shown in the drawings, the support and positioning member 35 can also comprise actuators, provided to move the arm 37 vertically, that is, in a direction parallel to the longitudinal development of the column 36. In this way it is possible to suitably position the milling tool 34 in order to control the position of the incision on the lateral surface of the wheel of cheese 11.

According to possible variant embodiments, for example shown in FIG. 3, it can be provided that the incision devices 33 comprise more than one milling tool 34, each of which is configured to incise the wheel of cheese 11 circumferentially at predetermined heights. In this way, by activating the incision devices 33 all the milling tools 34 are simultaneously activated, obtaining several incisions simultaneously.

According to possible embodiments, and if several milling tools 34 are present, each of them, or at least some of them, can be served by positioning devices configured to position the milling tools 34 reciprocally with respect to each other and allow to obtain incisions at different heights. According to other variant embodiments, not shown in the drawings, and possibly combinable with the embodiments described here, the incision devices 33 can also comprise activator/de-activator members configured to selectively activate or de-activate one milling tool 34 rather than the other.

According to possible embodiments, the incision devices 33 can also be served by suction devices 38, configured to take in the milling offcuts that are generated when the milling tool 34 is activated.

According to a possible solution, the suction devices 38 can comprise a suction pipe 39 connected to suction members not shown in the drawings. The suction pipe 39 can be mounted on the incision devices 33, for example near the milling tool 34.

According to a possible embodiment, the suction devices 38 are integrated in the incision devices 33, for example providing that the suction pipe 39 is integrated into the support arm 37 of the milling tool 34, and acts directly near the milling tool 34.

The suction devices 38 can comprise, merely by way of example, suction members of the Venturi type.

The incision operations provide to take the milling tool 34 against the circumferential surface of the wheel of cheese 11. In this condition, the rotation of the support body 23 is activated around the longitudinal axis Z, to allow to make the groove on the wheel of cheese 11.

According to a possible variant embodiment, instead of making the support body 23 rotate, it is provided that the support and positioning members 35 move the milling tool around the wheel of cheese 11 to make the groove.

Possible implementations of the method can provide that after the operation to incise the wheel of cheese 11, the operation to cut it follows, using the wire 27.

According to a possible variant of the method according to the present invention, it can be provided that the incision operation is at least partly simultaneous to the cutting operation. According to this variant embodiment, it can be provided, for example, that the incision operation with the incision devices 33 is carried out for at least half the circumferential development of the wheel of cheese and, when this condition is reached, the cutting devices 25 are activated. In this condition the cutting devices 25 dispose the wire 27 in the already incised portion of the wheel of cheese 11 and are activated so that the cutting of the disk 12 is begun.

During the cutting operation by the wire 27, the incision devices 33 continue their incision action on the remaining surface portion that is not incised.

The at least partial overlapping of the incision operation with the cutting operation allows to reduce, and almost halve, the time required to cut a disk 12.

According to possible solutions, the support body 23 can comprise centering devices 43, shown for example in FIG. 5 and configured to center the wheel of cheese 11 and keep it in a centered position at least during the transverse cutting operations to obtain disks 12, and possibly during the incision operation.

According to a possible formulation of the invention, the centering devices 43 comprise a plurality of blades 44 with an oblong development, pivoted near their end, in an angularly offset position, circumferentially on the support platform 24.

The blades 44 are located during use protruding from the support surface of the support platform 24, so as to contact, when actuated, the wheel of cheese 11 that is put on the support platform 24.

The blades 44 are configured to assume at least a first operating position in which they are disposed with their oblong development substantially tangent to the perimeter development of the support platform 24, and a second operating position in which the free ends of the blades 44 face toward the internal part of the support platform 24.

In the second operating position, the blades 44 contact the perimeter surface of the wheel of cheese 11, exerting a centering action.

The centering devices 43 can also comprise activator members 45, configured to take the blades 44 selectively from their first operating position to their second operating position or vice versa.

According to possible embodiments, the activator members 45 comprise at least one linear actuator 46, in this case a plurality of linear actuators 46, each of which is connected to a respective blade 44. The activation of the linear actuator 46 causes the rotation of the respective blade 44 around the point where it is pivoted, in order to take the blade 44, or not, into contact with the wheel of cheese 11.

The activator members 45 can also be connected to synchronization members 47, configured to synchronize the movement of all the blades 44 at least in their passage from their first operating position to their second operating position.

According to the embodiment shown in FIG. 5, the synchronization members 47 can comprise a toothed wheel 48, in this case with segmented teeth, located coaxial with the support platform 24. On the toothed wheel 48 a plurality of toothed sectors 49 engage, each of which is pivoted radially and externally to the toothed wheel 48, in correspondence with one of the pivoting points of the blades 44 on the platform 24. Each blade 44 is solidly attached to one of the toothed sectors 49 in correspondence with its pivoting point with the support platform 24. One of the linear actuators 46 is radially attached to each toothed sector 49, and in this case is a pneumatically actuated linear actuator. The actuation of each linear actuator 46 determines the rotation of the toothed sector 49 which not only rotates the blade 44 connected to it, but also makes the toothed wheel 48 rotate and hence also the other toothed sectors 49.

Even if not completely simultaneous, the actuation of the linear actuators 46 therefore ensures the centering action of the wheel of cheese 11 on the support platform 24.

According to a possible variant, not shown, the disking unit 13 can be provided with a holding member configured to hold the wheel of cheese resting against the support platform 24.

The holding member can comprise, for example, at least a thrust element positionable above the wheel of cheese and movable toward it to exert a holding pressure on the wheel of cheese against the support platform 24.

According to possible embodiments, possibly combinable with other embodiments described here, the disking unit 13 comprises a manipulator device 50 configured to move the disks 12 from the disking unit 13 toward the coring unit 14.

In possible formulations of the invention, the manipulator device 50 is configured to hold the wheel of cheese 11 in position on the support body 23 during the cutting operations and possibly the incision operations.

According to some embodiments, the manipulator device 50 can comprise a robot, a gripper, a depression gripping head, suckers or similar and comparable devices suitable for the purpose.

According to a possible embodiment, shown by way of example in FIG. 3, the manipulator device 50 comprises a sucker-type gripping head 51 configured to manipulate the disk 12 being cut, through a depression action.

The sucker-type gripping head 51 can be mounted on a movement device 52 configured to move it in the predetermined directions.

The movement device 52 can comprise a support element 53, for example a column with a longitudinal development, connected to the base of the disking unit 13, and a support arm 54 mounted cantilevered on the support element 53.

The sucker-type gripping head 51 is mounted on the free end of the support arm 54.

The movement device 52 can be served by actuation members provided to move the support element 53 and/or the support arm 54 in order to position the sucker-type gripping head 51 in the disking unit 13 in a predetermined manner.

Merely by way of example, the actuation members provided to move the support element 53 and the support arm 54 can comprise telescopic mechanisms, linear actuators, electric motors, worm screw mechanisms, rack mechanisms or possible combinations thereof.

According to some solutions, between the support arm 54 of the movement device 52 and the sucker-type gripping head 51 a positioning member 55 is interposed, configured to move the sucker-type gripping head 51 vertically, that is, in a direction parallel to the longitudinal development of the support element 53. The positioning member 55 can comprise, for example, a linear actuator, such as for example a pneumatic actuator.

Thanks to the presence of the movement device 52, the sucker-type gripping head 51 can be taken to a first position to pick up and/or hold the wheel of cheese 11 and/or the cut disk 12 on the support body 23, and at least a second position to deliver a cut disk 12 to the operating unit located downstream.

The vertical movement of the sucker-type gripping head 51 caused by the positioning member 55 also allows to exert the desired holding and/or pick-up action.

In some formulations, the sucker-type gripping head 51 can also be taken to a third position, or position where the working offcuts are discharged. The third position, as will be described hereafter, for example allows to discharge from the cutting devices 25 layers of crust of the wheel of cheese 11 cut into disks.

According to one of the possible solutions, the sucker-type gripping head 51 can comprise a base body 56, substantially circular in shape, with which a plurality of suckers 57 are associated.

The suckers 57 can be disposed reciprocally distanced on the perimeter of a circumference. This disposition allows to grip the disks 12 even when already cored in their central part.

The sucker-type gripping head 51 is in turn connected to an apparatus to generate a vacuum condition, not shown in the drawings, which provides to selectively drive the suckers 57.

In possible solutions, each sucker 57 is connected to the apparatus to generate a vacuum for example by connection pipes.

The disking unit 13 can be provided, as described above, with a station 64 to discharge working offcuts, such as disks 12 of cheese crust, to discharge them from the production line.

According to the embodiment shown in FIG. 3, the discharge station 64 comprises a plurality of rolls 65 mounted idle on a support frame 66. When it moves to this third position, the sucker-type gripping head 51 provides to discharge the working offcuts onto the plurality of rolls 65. The rolls 65 determine the lateral discharge of the offcuts.

The manipulator device 50 can be configured to dispose the cut disks 12 near the entrance to the coring unit 14.

In correspondence with its entrance zone, the coring unit 14 can be provided with an upending member 93, an example of which is shown in FIG. 9.

The upending member 93 can be configured to upend the disks 12 that are cut in the disking unit 13 and make them available to the coring unit 14 with a predefined face facing upward. The upending member 93 can be used for example if only two disks 12 are obtained from a wheel of cheese 11, that is, two half wheels each with its own crust. In this case it is necessary to arrange the two disks 12 for the units downstream, both with their crust facing in the same direction.

The upending member 93 can comprise for example two gripping heads 94 disposed on one side and the other of the support plane 20 and configured to take the disk 12 to diametrically opposite positions.

The gripping heads 94 can be served by rotation members 95 configured to make the gripping heads 94 rotate around an axis of rotation Y located substantially orthogonal to the working axis X, and by positioning members 96 configured to move the gripping heads 94 both in a direction orthogonal to the support plane X and also in a direction parallel to the axis of rotation Y to take the gripping heads 94 toward/away from each other.

By suitably coordinating the actuation of the rotation members 95 and the positioning members 96, it is possible to cause the upending of the disks 12.

FIGS. 1, 2, 7 and 8 are used to describe possible embodiments, possibly combinable with the embodiments described here, of the coring unit 14.

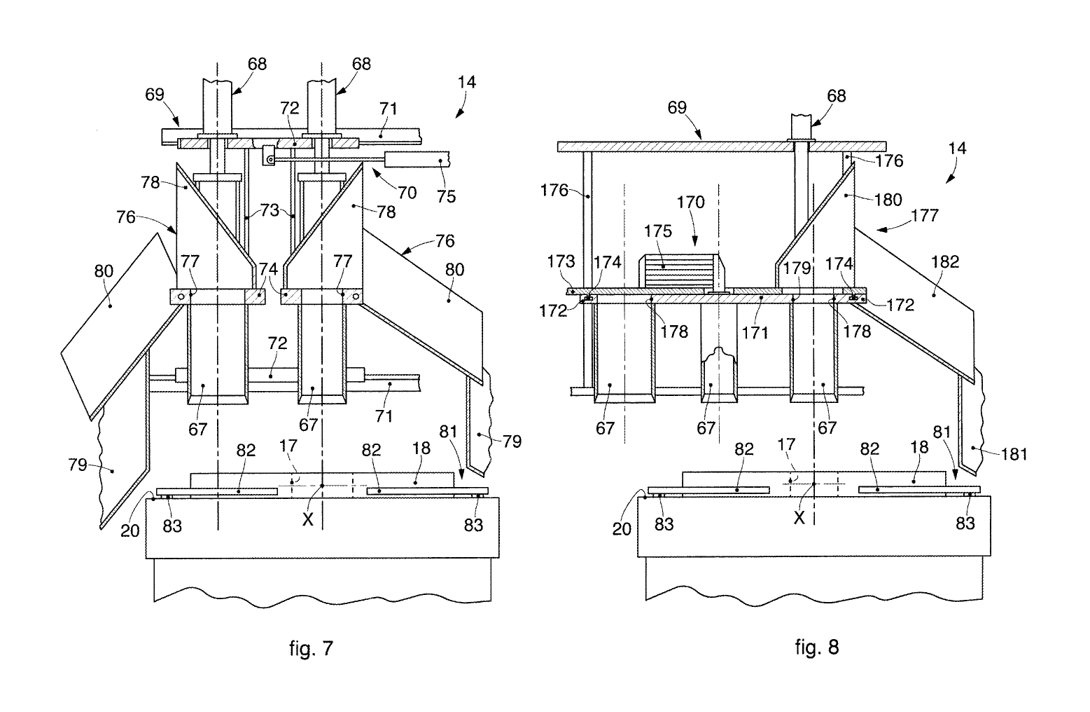

The coring unit 14 comprises at least a coring tool 67, in FIG. 7 two coring tools 67, selectively actuated by respective actuation members 68. The actuation members 68 are configured to activate the coring tool 67 toward the support plane 20, and make the hole 17 on the disk 12.

The coring tools 67 can have a substantially tubular shape, with a circular, square or rectangular cross section shape, or other desired shapes. At least one end of the coring tools 67 is conformed as a blade to make the hole 17.

The coring tools 67 are mounted on a support frame 69 located above the support plane 20.

The actuation members 68 can comprise linear actuators, jack screws, worm screw mechanisms, rack mechanisms, motors or similar and comparable members suitable for the purpose.

If the coring unit 14 comprises several coring tools 67, it can be provided that each of them has a size and/or shape different from the others.

If the coring unit 14 comprises several coring tools 67, selection members 70 can be installed on the support frame 69, provided to select, that is, to selectively move to an active position, one coring tool 67 rather than the other.

With reference to FIG. 7, a first embodiment is described in which the selection members 70 are configured to selectively activate one of two coring tools 67.

The selection members 70 comprise guides 71 attached to the support frame 69 and sliders 72 mounted sliding on the guides 71 above the support plane 20.

The coring tools 67 are mounted on the sliders 72 by means of bars 73 and support plates 74.

In particular, each coring tool 67 is attached to a support plate 74 which is mounted sliding on the bars 73. The bars 73 in turn connect two sliders 72 with each other, mounted sliding on respective guides 71 disposed distanced from each other on the support frame 69. The actuation members 68 are mounted on the slider 72 located above and are connected with a first end to one of the support plates 74 on which the coring tool 67 is mounted. The lower slider 72 can comprise guide members, not shown in the drawings, and configured to guide the movement of the coring tool 67 toward the support plane 20.

At least one of the sliders 72 is connected to a linear actuator 75 provided to selectively displace the sliders 72 on the guides 71 and take to the active condition one coring tool 67 rather than the other.

In particular, the linear actuator 75 is configured to dispose the coring tool 67 selected with its axis of action substantially incident with the working axis X of the apparatus 10. In this way, when a disk 12 is put under the coring tool 67, it is possible to make the hole 17 directly.

Each coring tool 67 can be served by a respective discharge device 76 to discharge the material removed to make the hole 17 in the disk 12.

The material removed to make the hole 17 during the coring operation remains inside the cavity defined by the coring tool 67. Successive coring operations take the material removed to slide axially along the coring tool 67, to then be expelled through the opposite end to that where the cutting blade is provided. To this purpose, each support plate 74 on which the coring tool 67 is mounted is provided with a discharge hole 77 through which the removed material passes and is discharged.

A casing 78 can be attached to each support plate 74, configured to temporally contain and discharge the removed material to a discharge zone 79.

Between each casing 78 and each discharge zone 79 a connection channel 80 can be provided, for example obtained by bending metal sheet, which allows to transfer the removed material from the casing 78 toward the discharge zone 79.

Each connection channel 80 can be connected to the support plates 74, for example by hinging, to promote the movements to which the latter are subjected for the selection of the coring tools 67.

With reference to FIG. 8, a second embodiment is described in which the selection members, identified here by the reference number 170, are configured to activate one of a plurality of coring tools 67, in this case four coring tools 67, of which only three are shown in the drawing.

In this embodiment, it can be provided that the coring tools 67 are mounted, with one end, on a circular platform 171 in a disposition on the perimeter of a circumference, the center of which corresponds with the center of the circular platform 171.

The circular platform 171 is provided with first circular guide elements 172.

A support plate 173 is provided with second circular guide elements 174 on which the first circular guide elements 172 are mounted sliding.

The first 172 and second circular guide elements 174 allow to rotate the circular platform 171 around its center and with respect to the support plate 173.

A drive member 175 is attached on the support plate 173 and is connected to the circular platform 171. The actuation of the drive member 175 causes the circular platform 171 to rotate, and hence also the coring tools 67 mounted on it. Each coring tool 67 can be taken to an active position to make the hole 17 on the disk 12.

The support plate 173 is in turn mounted slidingly in a direction parallel to the longitudinal extension of the coring tools 67, on guide bars 176 attached to the support frame 69.

The actuation member 68 is attached on the support frame 69, and provides to move the support plate 173 along the guide bars 176 and causes the actuation of the coring tool 67 to make the hole 17.

However, it is not excluded that in other embodiments each coring tool 67 can be provided with its own actuation member, configured to selectively activate the respective coring tool 67.

In this embodiment too, discharge devices 177 can be provided to discharge the material removed to make the hole 17. The circular platform 171 is in fact provided with a plurality of discharge holes 178, each of which is made continuous with the tubular cavity of one of the coring tools 67.

The support plate 173 is in turn provided, in correspondence with the active position of the coring tool 67, with a through hole 179, which is disposed on each occasion aligned with the discharge hole 178 corresponding to the coring tool 67 that is activated.

In correspondence with the through hole 179, a casing 180 is mounted on the support plate 173, in which the material removed to make the hole 17 is temporally contained and discharged.

The material removed is discharged to a discharge zone 181. Between the casing 180 and the discharge zone 181 a connection channel 182 can be provided, to allow to transfer the material removed from the casing 180 to the discharge zone 181.

The connection channel 182 can be obtained by bending metal sheet.

According to a possible embodiment, the connection channel 182 can be connected to the support plate 173 by pivoting, to promote the movements to which the latter is subjected when the actuation member 68 is activated.

According to possible embodiments of the invention, the coring unit 14 can also comprise centering members 81 configured to center precisely the disk 12 that is cored, in order to dispose it in a centered position aligned with the axis of action of the coring tool 67 that is driven.

According to possible embodiments, the centering members 81 are attached above the support plane 20.

According to some formulations of the present invention, the centering members 81 can comprise a plurality of centering blades 82 mounted at the sides of the support plane 20 and selectively drivable to be disposed each in contact against the circumferential surface of the disk 12 being worked.

In particular, it can be provided that the centering blades 82 are pivoted, in correspondence with their first ends, by means of pins 83 mounted on the support plane 20 according to a disposition on the perimeter of a circumference.

Activator members, not shown in the drawings, are connected to the pins 83 and are configured to take the centering blades 82 to a non-operating position, not interfering and/or not in contact with the disk 12 of cheese, and an operating position, in which they are rotated around the pins 83 and reciprocally approaching each other to contact the disk 12 that is interposed between them.

According to possible formulations of the present invention, the support plane 20 can be defined by a movement member, in this case a conveyor belt 84 (FIG. 1) configured not only to support the disks 12 which are disposed on it on each occasion, but also to make them advance along the working axis X and toward the units located downstream.

According to possible embodiments, for example the one shown in FIGS. 1 and 2, the weighing unit 15 is located downstream of the coring unit 14.

The weighing unit 15 can comprise scales or load cells, to directly assess the weight of the intermediate product 18 obtained in the coring unit 14.

According to variant embodiments of the invention, the weighing unit 15 can comprise optical acquisition devices, configured to detect the shape, size and possible discontinuities of the intermediate product 18 obtained. This allows to subsequently optimize the cutting into segments 19 of the intermediate product 18 to guarantee that segments 19 are obtained with a uniform weight.

The weighing unit 15 can be served by presence detectors, for example photocells, provided to detect the presence of the intermediate product 18 which is loaded on each occasion, at least to estimate the weight.

Possible solutions can provide that the weighing unit 15 comprises a movement member, in this case a transport member 85 provided to move the intermediate product 18 along the working axis X and toward the operating unit located downstream.

The transport member 85 in this case comprises a conveyor belt, although the use of other types of transporters is not excluded, for example thrust members.

FIGS. 1 and 2 are used to describe possible solutions of the cutting unit 16.

The cutting unit 16 comprises a substantially flat cutting blade 86 which in one embodiment extends for a length substantially equal to the diameter of the intermediate product 18 from which the segments 19 are to be obtained. In this embodiment, the cutting blade 86 makes a cut on the intermediate product 18 that extends substantially for the entire diameter of the latter.

According to possible variant embodiments, the cutting blade 86 has a width substantially equal to the radius of the intermediate product 18 from which the segments 19 are to be obtained. In this case the cutting blade 86 is configured to cut the intermediate product 18 substantially on the radius thereof.

The cutting blade 86 is connected to actuation members 87 configured to move the cutting blade 86 linearly toward the support plane 22 disposed below.

The actuation members 87 can comprise a screw jack, an electric motor, mechanical kinematisms, toothed wheels, rack mechanisms, articulated kinematisms or possible combinations thereof.

Rotary members are also connected to the cutting blade 86, provided to rotate the cutting blade 86 angularly and allow to obtain segments 19 of desired angles.

The cutting unit 16 can also be served by holding and centering members 88, configured to hold and center the intermediate product 18 during the cutting operations with the cutting blade 86.

According to possible embodiments, the holding and centering members 88 can be configured as an orange peel grab.

The holding and centering members 88 can comprise a plurality of holding arms 89 mounted on a support and actuation platform 90 in a disposition on the perimeter of a circumference.

The holding arms 89 can be pivoted to the support and actuation platform 90 so that a selective movement of the latter can take the holding arms 89 to an open position, not in contact with the intermediate product 18 being worked, or selectively to a closed position, in which all the holding arms 89 simultaneously cooperate to hold the intermediate product 18 interposed between them.

Actuation members 91 can be connected to the support and actuation platform 90, configured to selectively move the latter and take it to the position of holding arms 89 open or closed.

According to possible formulations of the present invention, the support plane 22 of the cutting unit 16 can be defined by a movement member, in this case a conveyor belt 92, which not only supports the intermediate product 18 but also causes it to advance along the working axis X.

According to possible embodiments, the apparatus 10 according to the present invention can also comprise a loading unit 96, disposed upstream of the disking unit 13 and configured to load on each occasion on the latter a wheel of cheese 11 to be processed.

The loading unit 96 can comprise a store 97 configured to support a plurality of wheels of cheese 11 to be sent for working.

The store 97 can comprise for example a support bench or platform on which the wheels of cheese 11 are disposed, organized in stacks for example.

The loading unit 96 is served by at least one gripping member 98, configured to pick up a wheel of cheese 11 at a time from the store 97 and make it available to the disking unit 13, for example in correspondence with the support body 23.

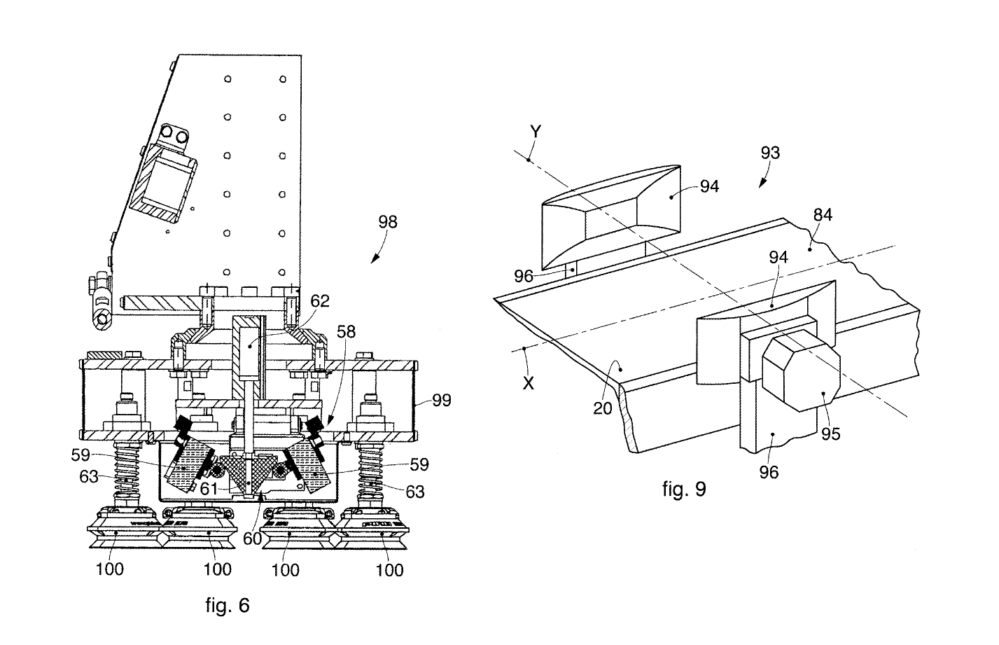

According to possible embodiments, the gripping member 98 can comprise at least one base body 99 with which one (FIG. 1) or more suckers 100 (FIG. 6) are associated.

In this latter case, the suckers 100 can be disposed reciprocally distanced on the perimeter of a circumference. This disposition, unlike one sucker located centrally, guarantees to grip and/or hold wheels of cheese 11 even when they have already been cored in the central part.

The gripping member 98 is in turn connected to an apparatus to generate a vacuum condition, not shown in the drawings, which provides to selectively drive the suckers 100.

In possible solutions, each sucker 100 is connected to the vacuum generation apparatus for example by connection pipes.

In possible variant embodiments, the vacuum generation apparatus can be connected in a single depression chamber, for example defined by the base body 99, in which the suckers 100 are connected.

The suckers 100 can be coupled with the base body 99 for example by elastic elements 63, which allow to cushion the contact conditions with the wheel of cheese 11 and/or the disks 12. The elastic elements 63 can comprise cushioning devices, compression springs, pistons, telescopic elements or possible combinations thereof.

According to possible formulations of the present invention, the gripping member 98 can also be served by optical acquisition devices 58 (FIG. 6), configured to acquire an image of the wheel of cheese 11 that will be handled and allow a central positioning of the gripping member 98.

According to the embodiment shown in FIG. 6, the optical acquisition devices 58 can comprise at least a TV camera, or photocell 59, in this case two photocells 59, mounted directly on the base body 99.

The photocells 59 can be mounted on the central portion of the base body 99.

The photocells 59 can also be served by positioning elements 60 configured to move the latter and allow them a different positioning, in order to adjust the filming angle.

According to possible solutions, the positioning elements 60 can comprise a support 61 on which the photocells 59 are mounted. In particular, it can be provided that the photocells 59 are pivoted to the support 61 so that a movement of the latter entails a coordinated movement of the photocells 59 that thus modifies the filming angle.

To this purpose, the support 61 is connected to a linear actuator 62 provided to move the support 61 linearly, in this case in a substantially vertical direction. Elastic recall mechanisms can be provided between the photocells 59 and the base body 99 to keep the position of the photocells 59 determined by the movement of the support 61.

The gripping member 98 can be mounted on a Cartesian pantograph 101 disposed between the zone occupied by the store 97 and the disking unit 13. In particular, the Cartesian pantograph 101 comprises beams 102 disposed parallel to the working axis X and that extend between the store 97 and the disking unit 13.

The gripping member 98 can therefore be moved both in a direction parallel to the working axis X and also in a direction transverse thereto, allowing to reach the various pick-up and delivery zones of the wheels of cheese 11.

According to possible solutions of the present invention, the apparatus 10 can be provided with a management and control unit 103 connected at least to the coring unit 14, the weighing unit 15 and the cutting unit 16 and configured to reciprocally synchronize their functioning. In this way the units 14-16 are reciprocally and functionally interconnected, preventing possible overlapping movements of the disks 12, the intermediate products 18 and the segments 19. In particular, the management and control unit 103 is configured to manage the functioning of each unit 14-16 so as to set the production cadence of each of them.

According to variant embodiments, it can be provided that the management and control unit 103 is also connected to the disking unit 13, to synchronize the functioning of the latter with those of the other units 14-16.

According to possible embodiments, the management and control unit 103 can also be connected to the movement members 84, 85, 92 as described above, to set the movement cadence of the entire apparatus 10.

It is clear that modifications and/or additions of parts may be made to the apparatus for processing a food product and the corresponding method as described heretofore, without departing from the field and scope of the present invention.

It is also clear that, although the present invention has been described with reference to some specific examples, a person of skill in the art shall certainly be able to achieve many other equivalent forms of apparatus for processing a food product and the corresponding method, having the characteristics as set forth in the claims and hence all coming within the field of protection defined thereby.

1. Apparatus for processing a food product, such as a wheel of hard or semihard cheese, comprising the following units located in sequence:
a disking unit configured to cut said food product and to obtain disks;
a holing unit configured to make a hole in each of said disks to define an intermediate product shaped like a do-nut;
a weighing unit configured to assess the weight of at least one of said disks or said intermediate product;
a cutting unit configured to cut said intermediate product into a plurality of segments,
said holing unit, said weighing unit and said cutting unit being positioned adjacent to each other and aligned along a common working axis.

2. Apparatus as in claim 1, wherein movement members are provided in, or among, said holing unit, said weighing unit and said cutting unit in order to move at least said disks, said intermediate product and said segments along said working axis.

3. Apparatus as in claim 1, wherein said holing unit, said weighing unit and said cutting unit are provided with respective work planes all lying aligned on a single plane.

4. Apparatus as in claim 1, in that it comprises a management and control unit connected at least to said holing unit, said weighing unit and said cutting unit and configured to reciprocally synchronize their functioning.

5. Apparatus as in claim 1, wherein said disking unit comprises a support body on which to dispose said food product and cutting devices configured to cut said food product into disks.

6. Apparatus as in claim 5, wherein said cutting devices comprise a plurality of cutting tools, configured to cut several disks simultaneously from said food product.

7. Apparatus as in claim 1, wherein said disking unit comprises incision devices configured to superficially incise the lateral surface of said food product and to generate on said food surface at least one circumferential groove or incision.

8. Apparatus as in claim 7, wherein said incision devices comprise a plurality of milling tools each of which is configured to incise said food product circumferentially and to make simultaneously respective circumferential grooves or incisions.

9. Apparatus as in claim 1, wherein said disking unit comprises a manipulator device configured at least to move said disks from said disking unit toward said holing unit.

10. Apparatus as in claim 1, wherein said holing unit comprises a plurality of coring tools connected to actuation members configured to selectively move at least one of said coring tools against said disks and to make said hole, selection members being provided to selectively select one of said coring tools.

11. Apparatus as in claim 1, wherein said cutting unit comprises a cutting blade connected to actuation members configured to move said cutting blade linearly toward said intermediate product and rotation members provided to rotate said cutting blade angularly and to determine the amplitude of the angle of said segments.

12. Apparatus as in claim 1, wherein said cutting unit comprises holding and centering members configured to hold and center said intermediate product during the cutting operations.

13. Method for processing a food product, such as a wheel of hard or semihard cheese, comprising the following operations in sequence:
cutting said food product into a plurality of disks;
making a hole in each of said disks to define an intermediate product shaped like a do-nut;
assessing the weight of at least one of said disks or of said intermediate product;
cutting said intermediate product into a plurality of segments,
said operations of making said hole, assessing the weight and cutting said intermediate product being carried out one after the other along a common working axis.

14. Method as in claim 13, which also comprises superficially incising the lateral surface of said food product to generate on said lateral surface at least a circumferential groove or incision, and wherein cutting said food product into a plurality of disks is carried out at least partly simultaneously with the superficial incision of said lateral surface of said food product.
